(19) United States
(12) Patent Application Publication
(10) Pub. No.: US 2007/0189020 A1
(43) Pub. Date: Aug. 16, 2007

(54) Lamp enclosure

(76) Inventors: Chao-Chuan Chen, Taichung City (TW); Yun-Hui Tu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/352,248

(22) Filed: Feb. 13, 2006

(51) Int. Cl. F21V 15/00

(52) U.S. Cl. 362/362

(57) ABSTRACT

A lamp enclosure comprises a cover made of elastic material for covering upon a lamp so that light emitted from the lamp will feel soft and comfortable. The cover is made of fireproof material. A surface of the cover has a plurality of holes and the surface of the cover is added with at least one decoration. Furthermore, at least one wing is added to a lower portion of the cover. The lamp enclosure has a simple structure and is cheap. Furthermore, the lamp enclosure has a small volume so as to save space for storage.

### FIELD OF THE INVENTION

The present invention relates to lamps, and particularly to a lamp enclosure for adjusting the illumination of a lamp. The lamp enclosure of the present invention has a simple structure and is cheap. Further, the lamp enclosure of the present invention has a small volume so as to save space for storage.

### BACKGROUND OF THE INVENTION

Referring to FIG. 1, a prior art lamp is illustrated. The lamp has a seat 90, a bulb 91 and a lamp shade 92. Generally, the illumination of the lamp is uncontrollable. The lamp can only be actuated and closed. Thereby the user can not adjust the illumination as desired, for example, for sleeping.

In the prior art for controlling the illumination of the lamp, a paper or other shielding object is used to cover the lamp shade 92 of the lamp. However the covering object is not fixed and it is often that the object is burnable.

In the improvement structure, lamps with adjustable illumination are developed, but their prices are high. Further old lamp must be deserted.

### SUMMARY OF THE INVENTION

Accordingly, the primary object of the present invention is to provide a lamp enclosure for adjusting the illumination of a lamp. The lamp enclosure of the present invention has a simple structure and is cheap. Further, the lamp enclosure of the present invention has a small volume so as to save space for storage.

To achieve above objects, the present invention provides a lamp enclosure which comprises a cover made of elastic material for covering upon a lamp so that light emitted from the lamp will feel soft and comfortable. The cover is made of fireproof material. A surface of the cover has a plurality of holes and the surface of the cover is added with at least one decoration. Furthermore, at least one wing is added to a lower portion of the cover.

The various objects and advantages of the present invention will be more readily understood from the following detailed description when read in conjunction with the appended drawing.

### BRIEF DESCRIPTION OF THE DRAWINGS

FIG. 1 is a schematic view about a prior art lamp.

FIG. 2 is an assembly view of the lamp of the present invention.

FIG. 3 shows the use of the present invention.

FIG. 4 shows the second embodiment of the present invention.

FIG. 5 shows the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

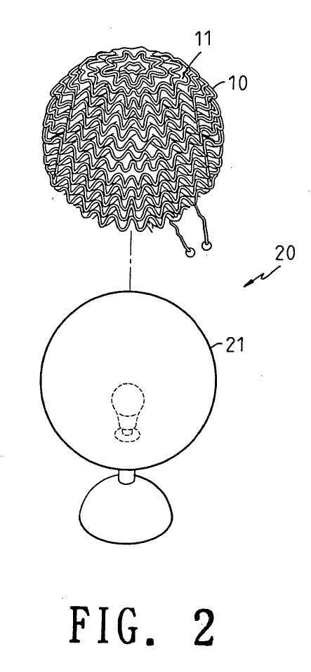

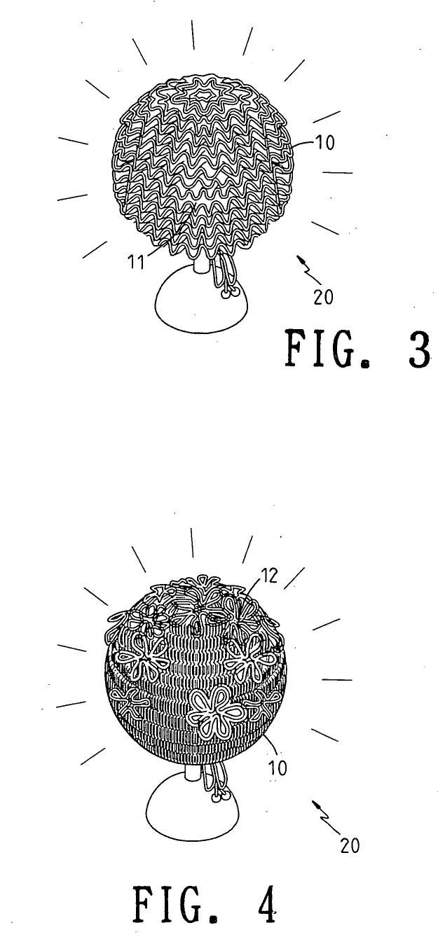

Referring to FIGS. 2 and 3, the lamp device with an enclosure of the present invention is illustrated. The present invention has the following elements.

A cover 10 has a non-smooth surface with a plurality of small holes 11. Thereby light can emit out from the holes 11. The cover 10 is made of soft and elastic material. Preferably, the cover 10 is mode of fireproof materials so as to prevent the burning of the cover 10 as the cover 10 covers upon a lamp which light up so as to generate heat.

A lamp 20 has a lamp shade 21 at an outer side of the lamp 20 and a bulb at an inner side of the lamp 20. In use, the cover 10, as shown in FIG. 2, is expanded and covers upon the lamp 20 for shielding light and reducing the illumination of the lamp 20, as illustrated in FIG. 3. Only a part of light emits out from the holes 11 of the cover 10, while other part of light can not emit out of the cover 10. Thereby the light from the lamp 20 with the cover 10 is soft and the user will feel easy. The light will not make the eyes of the user feel dizzy.

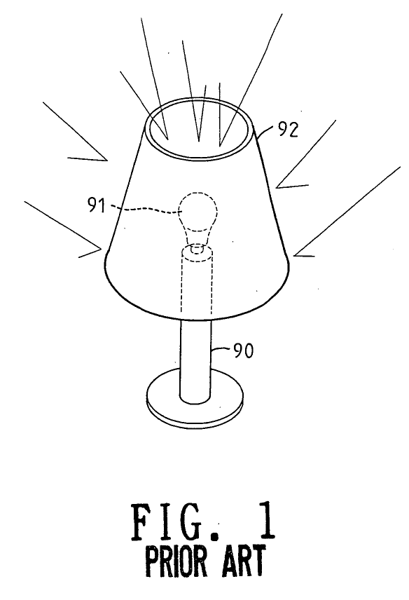

In FIG. 1, it is illustrated that the lamp shade 21 has a spherical shape. However the shape of the lamp 20 is not confined to a spherical shape. Other shapes are permissible, such as cylindrical shapes or tapered shapes. All these are within the scope of the present invention.

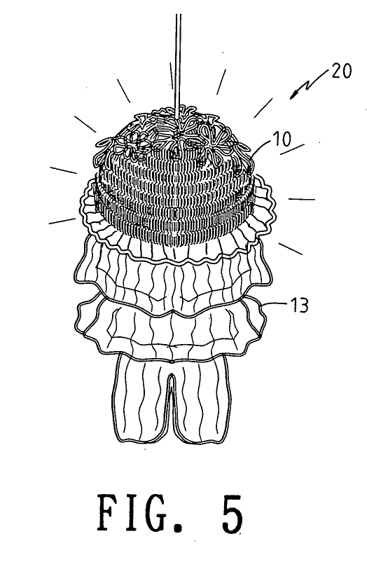

Referring to FIG. 4, the second embodiment of the present invention is illustrated. The elements like those in the first embodiment are numerated with the same numerals and the details thereof will not be described herein. In this embodiment, the cover 10 is added with a decoration 12 so as to have a beautiful outlook.

Referring to FIG. 5, the third embodiment of the present invention is illustrated. The elements like those in the first embodiment are numerated with the same numerals and the details thereof will not be described herein. In this embodiment, it is illustrated that the cover 10 has different shapes for being used with the lamp 20. In this embodiment, the cover 10 has at least one wing 13 at a lower side thereof (in this embodiment, there are two wings 13 are illustrated) so as to shield the light emitting out from the lower portion of the lamp 20.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A lamp enclosure comprising:
a cover made of elastic material for covering upon a lamp so that light emitted from the lamp will feel soft and comfortable.

2. The lamp enclosure as claimed in claim 1, wherein the cover is made of fireproof material.

3. The lamp enclosure as claimed in claim 1, wherein a surface of the cover has a plurality of holes.

4. The lamp enclosure as claimed in claim 1, wherein a surface of the cover is added with at least one decoration.

5. The lamp enclosure as claimed in claim 1, wherein at least one wing is added to a lower portion of the cover.
